(19) United States
(12) Patent Application Publication
(10) Pub. No.: US 2014/0227333 A1
(43) Pub. Date: Aug. 14, 2014

(54) DRY ACTIVE OXYGEN TECHNOLOGY

(71) Applicant: ECOLAB USA INC., St. Paul, MN (US)

(72) Inventors: Kim R. Smith, Woodbury, MN (US); Steven E. Lentsch, St. Paul, MN (US)

(73) Assignee: ECOLAB USA INC., St. Paul, MN (US)

(21) Appl. No.: 13/765,301

(22) Filed: Feb. 12, 2013

(51) Int. Cl. C09K 3/00

(52) U.S. Cl. CPC C09K 3/00
USPC 424/405; 252/186.25; 252/186.26; 252/186.28; 252/70; 252/601; 424/616; 510/375; 508/110; 508/154; 508/462; 508/136; 106/287.24; 106/287.23

(57) ABSTRACT

Active oxygen compounds, such as equilibrium peroxycarboxylic acid compositions are incorporated within an adsorbed outer layer of hydrophobic particulate component that remains undissolved from the active oxygen component. The dry powder compositions containing the active oxygen compounds provide a stable, controlled release composition having various applications of use. Beneficially, the dry powders delivering active oxygen compounds are low or no odor compositions and do not require the use of personal protective equipment for persons handling the compositions.

### FIELD OF THE INVENTION

The invention relates to the use of dry water technology for active oxygen compounds, such as hydrogen peroxide, peracid compositions such as peracetic acid, and the like. In particular, the compositions include an active oxygen component in a liquid droplet or aqueous form surrounded by a shell component of hydrophobic nanoparticles that remains undissolved from the liquid droplet of the active oxygen component. Methods of delivering the same active oxygen compounds are also provided that have controlled release and/or distribution of the active oxygen components of the composition. Beneficially, the dry powders delivering active oxygen compounds are low or no odor compositions.

### BACKGROUND OF THE INVENTION

Compositions including bleaching and other active oxygen oxidant agents are commonly formulated into powder or granule compositions. There is also interest in marketing and using such products in various the liquid forms. For example, detergent particle cleaning compositions can be formulated into liquid compositions having particulate components suspended therein. However, stability concerns are often presented by such formulations, such as disclosed in U.S. Pat. Nos. 7,435,714 and 7,588,697, which are incorporated herein by reference in their entirety. However, many of these compositions have various stability limitations, particularly when incorporating active oxygen components into the compositions, such as peroxycarboxylic acids (e.g. peracetic acid). Peracid compositions, namely peroxycarboxylic acid compositions, exhibit useful antimicrobial and bleaching activity and therefore would be desirable to formulate into stable powder or granule compositions (e.g., U.S. Pat. Nos. 5,200,189, 5,314,687, 5,409,713, 5,437,868, 5,489,434, 6,674,538, 6,010,729, 6,111,963, and 6,514,556, each incorporated herein by reference in its entirety).

Various applications of “dry water” technology have extended to use in formulating compositions using coated bleach or other active oxygen liquid compounds. Description of such “dry liquid” (or “dry water”) compositions was originally disclosed for example, by Degussa Corporation, Degussa Corporation Manuscript “Dry Water-a formulation principle with hydrophobic Aerosil®,” which is herein incorporated by reference in its entirety. Methods of using the technology to deliver water alone in a dry powder composition is disclosed by Forny et al., Powder Technology 171 (2007) 15-24, which is also incorporated herein by reference in its entirety.

U.S. Pat. No. 7,718,592, which is incorporated herein by reference in its entirety, discloses the use encapsulation of a particulate by another particle, which is distinct from “dry water” technology. Instead, “dry water” technology includes a droplet of liquid surrounded by hydrophobic nanoparticles on the surface of the droplet to afford an apparent powder even while the starting droplet remains in a liquid state. U.S. Publication Nos. 2010/0009889 and 2005/0233900, each of which are herein incorporated by reference in their entirety disclose the use of “dry water” technology with a hypochlorite solution inner droplet.

There is a need for dry water technology that provides a means of delivering (as a powder) a form of a liquid active oxygen solution which is only slightly reduced in concentration relative to the starting liquid. These and other limitations in the art are overcome by the present invention.

Accordingly, it is an objective of the claimed invention to develop dry active oxygen compositions that include a diphasic composition including an aqueous or liquid active oxygen component which has an adsorbed layer of a hydrophobic silica component, which is at least 80% of the starting liquid active oxygen component by weight; preferably at least about 90%.

A further object of the invention is to develop more stable dry-to-touch powder compositions containing an aqueous or liquid active oxygen oxidant within the compositions.

A still further object of the invention is to provide kits for use of the dry active oxygen compositions.

### BRIEF SUMMARY OF THE INVENTION

In an embodiment, the present invention provides a dry active oxygen composition including an aqueous active oxygen component and a hydrophobic component adsorbed to the outer layer of droplets of said active oxygen component. In an aspect the dry active oxygen composition forms a flowable, dry-to-touch powder formed by an adsorbed outer layer onto the liquid or aqueous droplets of the aqueous active oxygen component by the hydrophobic component which does not dissolve within the aqueous component for a period of time greater than at least 24 hours.

In a further embodiment, the present invention provides a kit comprising a sealed container, a dry active oxygen composition comprising an aqueous active oxygen component and a hydrophobic component adsorbed to the outer layer of droplets of said active oxygen component, and instructions for application of use.

In a still further embodiment, the present invention provides a method of using a dry active oxygen composition including combining an aqueous active oxygen component, and a hydrophobic nanoparticle component to form a composite of the hydrophobic nanoparticle component adsorbed onto the outer layer of droplets of liquid that is in the form of a flowable, dry-to-touch powder. The method also includes applying the dry active oxygen composition to a surface in need of treatment or storing the dry active oxygen composition within a sealed container for subsequent application to a surface in need of treatment. Optionally, the sealed container may contain a venting device as a safety feature.

In certain aspects, the dry active oxygen compositions are produced using an aqueous solution of peroxycarboxylic acids, sulfonated peroxycarboxylic acids, hydrogen peroxide and/or other active oxygen oxidants. In certain aspects, the dry active oxygen compositions are produced using a silica hydrophobic component, preferably wherein the silica component is not an alkali metal silicate, and wherein said silica component is a hydrophobically modified silica having at least about 30% of the hydroxyl groups of said silica modified with a silane to increase hydrophobicity. In certain aspects, the ratio of active oxygen component to hydrophobic component is from about 80:20 to about 97:3.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a cross-sectional view of an embodiment of the composite dry active oxygen composition 10 of the present invention showing at least one active oxygen component 11 within an encapsulate, hydrophobic shell component 12.

FIGS. 2-4 show graphs set forth in Example 4 demonstrating the thermostability of the active oxygen compositions formulated into the dry powder compositions according to embodiments of the invention.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENT

The embodiments of this invention are not limited to particular dry active oxygen delivery compositions and methods of use thereof, which can vary and are understood by skilled artisans. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form. Numeric ranges recited within the specification are inclusive of the numbers defining the range and include each integer within the defined range.

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism. For the purpose of this patent application, successful microbial reduction is achieved when the microbial populations are reduced by at least about 50%, or by significantly more than is achieved by a wash with water. Larger reductions in microbial population provide greater levels of protection.

As used herein, the term “disinfectant” refers to an agent that kills all vegetative cells including most recognized pathogenic microorganisms, using the procedure described in A.O.A.C. Use Dilution Methods, Official Methods of Analysis of the Association of Official Analytical Chemists, paragraph 955.14 and applicable sections, 15th Edition, 1990 (EPA Guideline 91-2). As used herein, the term “high level disinfection” or “high level disinfectant” refers to a compound or composition that kills substantially all organisms, except high levels of bacterial spores, and is effected with a chemical germicide cleared for marketing as a sterilant by the Food and Drug Administration. As used herein, the term “intermediate-level disinfection” or “intermediate level disinfectant” refers to a compound or composition that kills mycobacteria, most viruses, and bacteria with a chemical germicide registered as a tuberculocide by the Environmental Protection Agency (EPA). As used herein, the term “low-level disinfection” or “low level disinfectant” refers to a compound or composition that kills some viruses and bacteria with a chemical germicide registered as a hospital disinfectant by the EPA.

As used herein, the term “sanitizer” refers to an agent that reduces the number of bacterial contaminants to safe levels as judged by public health requirements. In an embodiment, sanitizers for use in this invention will provide at least a 99.999% reduction (5-log order reduction). These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). According to this reference a sanitizer should provide a 99.999% reduction (5-log order reduction) within 30 seconds at room temperature, 25±2° C., against several test organisms.

As used in this invention, the term “sporicide” refers to a physical or chemical agent or process having the ability to cause greater than a 90% reduction (1-log order reduction) in the population of spores of Bacillus cereus or Bacillus subtilis within 10 seconds at 60° C. In certain embodiments, the sporicidal compositions of the invention provide greater than a 99% reduction (2-log order reduction), greater than a 99.99% reduction (4-log order reduction), or greater than a 99.999% reduction (5-log order reduction) in such population within 10 seconds at 60° C.

Differentiation of antimicrobial “-cidal” or “-static” activity, the definitions which describe the degree of efficacy, and the official laboratory protocols for measuring this efficacy are considerations for understanding the relevance of antimicrobial agents and compositions. Antimicrobial compositions can affect two kinds of microbial cell damage. The first is a lethal, irreversible action resulting in complete microbial cell destruction or incapacitation. The second type of cell damage is reversible, such that if the organism is rendered free of the agent, it can again multiply. The former is termed microbiocidal and the later, microbistatic. A sanitizer and a disinfectant are, by definition, agents which provide antimicrobial or microbiocidal activity. In contrast, a preservative is generally described as an inhibitor or microbistatic composition

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

As used herein, the term “sulfoperoxycarboxylic acid,” “sulfonated peracid,” or “sulfonated peroxycarboxylic acid” refers to the peroxycarboxylic acid form of a sulfonated carboxylic acid. In some embodiments, the sulfonated peracids of the present invention are mid-chain sulfonated peracids. As used herein, the term “mid-chain sulfonated peracid” refers to a peracid compound that includes a sulfonate group attached to a carbon that is at least one carbon (e.g., the three position or further) from the carbon of the percarboxylic acid group in the carbon backbone of the percarboxylic acid chain, wherein the at least one carbon is not in the terminal position. As used herein, the term “terminal position,” refers to the carbon on the carbon backbone chain of a percarboxylic acid that is furthest from the percarboxyl group.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The methods and compositions of the present invention may comprise, consist essentially of, or consist of the components and ingredients of the present invention as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

Compositions

While an understanding of the mechanism is not necessary to practice the present invention and while the present invention is not limited to any particular mechanism of action, it is contemplated that, in some embodiments, the delivery of active oxygen components is provided in a dry liquid (or solid liquid) droplet formulation as a result of an unabsorbed, inner aqueous or liquid component in contact with an adsorbed layer (e.g. outer layer) of a hydrophobic particulate component. The compositions may be referred to herein as dry liquids, dry powders, solid liquids or the like. In an aspect, the compositions include a hydrophobic particulate shell comprised of undissolved particulate components surrounding a liquid or aqueous droplet containing an active oxygen component. In some aspects, the nature of the interaction between the hydrophobic particulate shell and the active oxygen containing liquid or aqueous droplet therein, may be a variety of cohesion forces allowing the adsorbed outer layer, such as van der Waals. In an aspect of the invention, the active oxygen component is an aqueous solution or suspension of at least an oxidant and a stabilizing compound. In the various aspects of the invention, the dry powder droplets do not result in droplet coalescence.

In an aspect of the invention the compositions include a dry liquid composition having a composite aqueous, active oxygen compound with shelf stability. In preferred aspects, the dry liquid compositions may be provided in a sealed container to prevent the evaporation and/or disintegration of the composition into an aqueous composition. Preferably, the dry liquid compositions within a sealed container (optionally containing a venting safety feature) have a shelf-stability of at least about 2 to 6 months, preferably at least about 6 to 12 months. The stability of the compositions upon exposure to ambient conditions will vary depending on such ambient conditions, including for example, temperature and humidity. In an aspect, the dry liquid compositions will convert into a liquid composition (having hydrophobic shell components contained therein) promptly upon exposure to shear force that disrupts the adsorbed layer of the hydrophobic shell component.

Without being limited to a particular theory of the invention, the present invention is distinct from prior art references with encapsulated compositions. Encapsulated compounds have a solid/particulate encapsulated by another solid/particulate. Distinctly, the present invention discloses a layer of hydrophobic nanoparticles adsorbed (yet not encapsulating) onto the outer surface of a liquid or an aqueous droplet. Notably, the droplet according to the invention remains in a liquid state even though the composite of the droplet (having the adsorbed particulate layer) is a powder.

Hydrophobic Shell Component

The compositions according to the invention include a hydrophobic shell component. The hydrophobic shell component may also be described as an adsorbed layer of hydrophobic particulate components, which may be referred to generally as a hydrophobic particulate component. The hydrophobic particulate component according to the invention is simply a layer of particulates floating on the surface of a droplet of liquid.

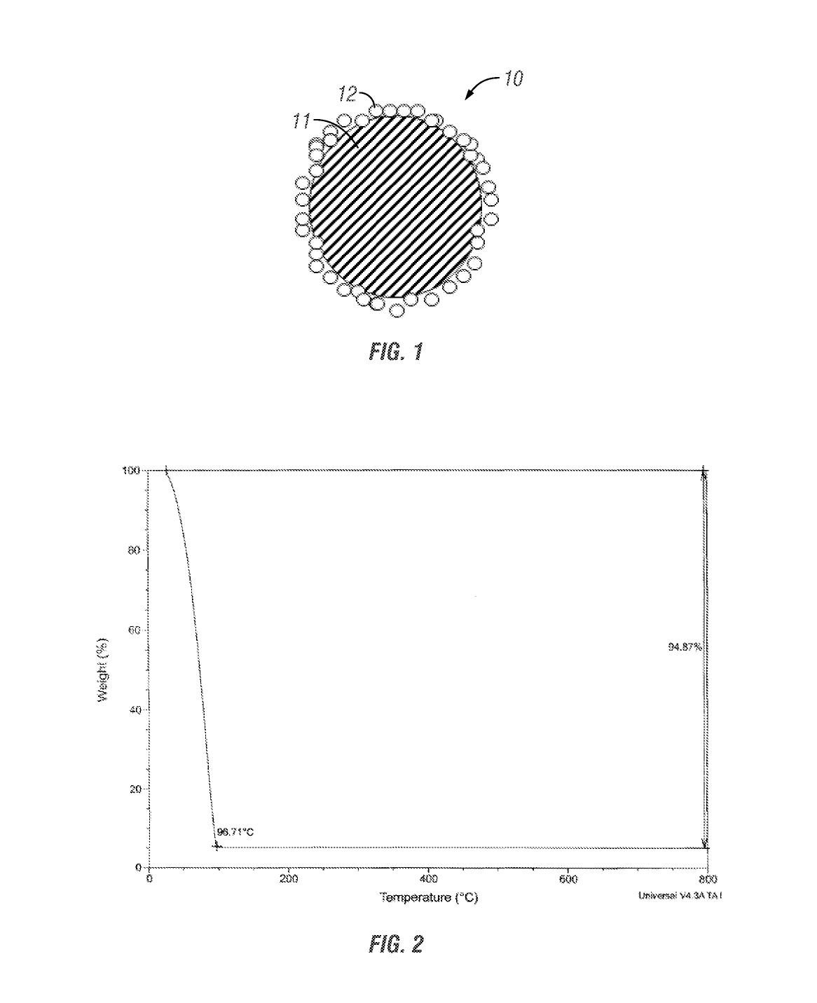

In an aspect, the hydrophobic particulate portion is made up of small particles or nanoparticles suitable for adsorbing to the active oxygen components of the compositions. In some aspects, the hydrophobic particulate component forms a porous shell or a non-continuous shell via its adsorption to the active oxygen components. Beneficially, the hydrophobic particulate component provides characteristics of a powder of nanoparticle solid, until such time as the dry active oxygen composition breaks down (e.g. by shear contact) and releases the liquid or aqueous component. In an aspect, the hydrophobic particulate shell component forms an outer adsorbed layer of particulate floating on the surface of liquid droplets for the dry powder compositions, effectively protecting, stabilizing, delaying and/or controlling the release and/or distribution of the active oxygen component contained there within, as shown in FIG. 1.

In an aspect of the invention, the hydrophobic particulate component according to the invention is water insoluble. In still further aspects of the invention, the hydrophobic particulate component is not substantially reactive with water.

Exemplary hydrophobic, water insoluble, solid particulates include hydrophobically-modified derivatives of silica, alumina, titanium, zinc, clay, and mixtures thereof. Preferably the hydrophobic, water insoluble, solid particulates are hydrophobically chemically-modified derivatives of silica, alumina, titanium, zinc, clay, and mixtures thereof.

Optionally, the solid particulates may be water-insoluble, solid particulates of hydrophilic silica, alumina, titanium, zinc, clay and mixtures thereof which have been physically modified by premixing with a water-insoluble cationic compound such that the resulting particulates are then hydrophobic in nature.

Exemplary silica for use as the hydrophobic particulate component includes chemically-modified silica, wherein the hydroxyl groups have been modified to impart hydrophobic properties. Preferably, the hydroxyl groups have been modified with a silane to increase hydrophobicity of the particulate. In an aspect, at least about 30% of the hydroxyl groups have been modified with a silane, and preferably at least 50% of the hydroxyl groups have been modified with a silane.

In a preferred aspect, the hydrophobicly modified silica is also a fumed silica. As referred to herein, fumed silica are composed of amorphous or crystalline silicon dioxide manufactured using a combustion process to produce silica having branched or aggregate networks of micron size (generally 20-30 μm). An example of a commercially-available, modified hydrophobically fumed silica is Aerosil® R812S, a fumed silica modified with an organosilane to impart hydrophobicity (Evonik Industries). Preferably, the modified silica has the silanol groups (Si—OH) substituted by dimethyl-dichlorosilane and hexamethyldisilazane groups. Exemplary descriptions of the physical and chemical properties of certain hydrophobically modified fumed silica available from Evonik Industries is set forth in Table 1.

TABLE 1

| | | BET | | | | Methanol |
|---|---|---|---|---|---|---|
| Aerosil ® | Primary particle size | surface | Tapped density | Substituted group | Carbon content | wettability |
| R812S | 7 nm | 220 m²/g | 50 g/L | 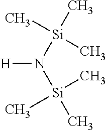 | 3-4% | 60% |
| R972 | 16 nm | 110 m²/g | 50 g/L | 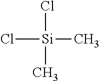 | 0.6-1.2% | 30% |

In a still further preferred aspect, the hydrophobic silica is not an alkali metal silicate or other silicate component that dissolves or is suspended within the active oxygen oxidant according to the invention. Instead, the hydrophobic particulate component forms an adsorbed outer layer around the active oxygen component.

In an aspect, the compositions include from about 0.01 wt-%-30 wt-% hydrophobic particulate component, from about 0.1 wt-%-20 wt-% hydrophobic particulate component, from about 0.1 wt-%-10 wt-% hydrophobic particulate component, preferably from about 1 wt-%-5 wt-% hydrophobic particulate component. In addition, without being limited according to the invention, all ranges recited are inclusive of the numbers defining the range and include each integer within the defined range.

In an aspect, the ratio of hydrophobic particulate component to the active oxygen component is from about 30:70 to about 2:98. In another aspect, the ratio of hydrophobic particulate component to the active oxygen component is from about 20:80 to about 3:97, preferably from about 10:90 to about 5:95. Without being limited according to the invention, all ranges recited are inclusive of the numbers defining the range and include each integer within the defined range.

In another aspect of the invention, the size of the composite droplet formed by the hydrophobic particulate component can be described according to the radius of the powder. In an aspect, r is the radius of a particle of the composite composition, assuming about equal densities for the liquid droplet and adsorbed layer of hydrophobic particulate and a monolayer of adsorbed hydrophobic particulate, wherein:

$$\frac{wt \% starting liquid}{wt \% starting particulate} ∼ \frac{volume of liquid droplet}{surface area of liquid droplet} = \frac{( 4 \text{/} 3 ) ( pi ) {r}^{3}}{4 ( pi ) {r}^{2}} = \frac{r}{3}$$

One skilled in the art would be able to use the above equation and by measuring the radius of the composite droplet develop an estimation of the weight ratio of the starting aqueous liquid and hydrophobic particulate in the composite. In an aspect the r value according to compositions of the invention is the weight ratio of the liquid active oxygen component to the hydrophobic particulate component and is equal to the radius of a droplet of the liquid component divided by 3.

Active Oxygen Component

The compositions according to the invention include an active oxygen component. The active oxygen component may include any active oxygen oxidant, including for example any water soluble active oxygen oxidant. The active oxygen component selected for formulation within the dry powder compositions is combined with the hydrophobic and water insoluble shell component to form a particle or nanoparticle composite composition that is substantially non-reactive in combination. In an aspect, the active oxygen component is substantially non-reactive with the hydrophobic particulate component.

Active oxygen oxidants are preferably provided as aqueous solutions of the active oxygen oxidant. Exemplary active oxygen oxidants include hydrogen peroxide, peroxy compounds, peroxycarboxylic acids and/or sulfonated peroxycarboxylic acids, persulfates, perborates, percarbonates, perphosphates, persilicates, other water-soluble active oxygen oxidants, urea, and the like.

According to an embodiment of the invention suitable peroxycarboxylic acids include ester peroxycarboxylic acids, alkyl ester peroxycarboxylic acids, sulfoperoxycarboxylic acids, and/or combinations of several different peroxycarboxylic acids, as described herein. Suitable peroxy compounds include, for example, aromatic or aliphatic peroxy compounds, including peroxycarboxylic acid. Suitable peroxycarboxylic acids include, for example, peracetic or peroctanoic acid, sulfonated percarboxylic acids, such as peroxy sulfonated oleic acid, and the like. A commercial example of a suitable active oxygen component is Oxonia® Active Concentrate, which is a mixture of peracetic acid, acetic acid, hydrogen peroxide, organophosphonate stabilizer, and water (Ecolab Inc.).

Peroxycarboxylic (or percarboxylic acid or peracids) refer synonymously to acids having the general formula R(CO₃H)ₙ. The R group can be saturated or unsaturated as well as substituted or unsubstituted. As described herein, R is an alkyl, aryl alkyl, cycloalkyl, aromatic, heterocyclic, or ester group, such as an alkyl ester group. N is one, two, or three, and named by prefixing the parent acid with peroxy. Ester groups are defined as R groups including organic moieties (such as those listed above for R) and ester moieties. Exemplary ester groups include aliphatic ester groups, such as R₁OC(O)R₂, where each of R₁ and R₂ can be aliphatic, preferably alkyl, groups described above for R. Preferably R₁ and R₂ are each independently small alkyl groups, such as alkyl groups with 1 to 5 carbon atoms.

As referred to herein, peroxycarboxylic acids preferably include short chain peroxycarboxylic acid (e.g., peroxyacetic acid) and/or medium chain peroxycarboxylic acids (e.g., octanoic acid). Peroxycarboxylic acids useful in the compositions according to the invention include, for example, peroxyformic, peroxyacetic, peroxypropionic, peroxybutanoic, peroxypentanoic, peroxyhexanoic, peroxyheptanoic, peroxyoctanoic, peroxynonanoic, peroxydecanoic, peroxyundecanoic, peroxydodecanoic, peroxylactic, peroxymaleic, peroxyascorbic, peroxyhydroxyacetic, peroxyoxalic, peroxymalonic, peroxysuccinic, peroxyglutaric, peroxyadipic, peroxypimelic, peroxysubric acid, or mixtures thereof. Medium chain peroxycarboxylic acids useful in the compositions of the present invention include peroxypentanoic, peroxyhexanoic, peroxyheptanoic, peroxyoctanoic, peroxynonanoic, peroxydecanoic, peroxyundecanoic, peroxydodecanoic, peroxyascorbic, peroxyadipic, peroxycitric, peroxypimelic, or peroxysuberic acid, mixtures thereof, or the like. Short chain peroxycarboxylic acids useful in the compositions and methods of the present invention include peroxyformic, peroxyacetic, peroxypropionic, peroxybutanoic, peroxyoxalic, peroxymalonic, peroxysuccinic acid, mixtures thereof, or the like. The alkyl backbones of these peroxycarboxylic acids can be straight chain, branched, or a mixture thereof. Peroxy forms of carboxylic acids with more than one carboxylate moiety can have one or more (e.g., at least one) of the carboxyl moieties present as peroxycarboxyl moieties. Peroxycarboxylic acids can also include the ester peroxycarboxylic acids described herein and compositions of the present invention including those ester peroxycarboxylic acids. Peroxy forms of carboxylic acids with more than one carboxylate moiety can have one or more of the carboxyl moieties present as peroxycarboxyl moieties.

In some embodiments of the invention at least one sulfoperoxycarboxylic acid is employed. Sulfoperoxycarboxylic acids, also referred to herein as sulfonated peracids, may also be used according to the invention and are understood to include the peroxycarboxylic acid form of a sulfonated carboxylic acid. The peroxycarboxylic acid chain can be sulfonated at a variety of locations. In some embodiments, the sulfonated peracids of the present invention are mid-chain sulfonated peracids, referring to a peracid compound that includes a sulfonate group attached to a carbon that is at least one carbon (e.g., the three position or further) from the carbon of the percarboxylic acid group in the carbon backbone of the percarboxylic acid chain, wherein the at least one carbon is not in the terminal position. As used herein, the term “terminal position,” refers to the carbon on the carbon backbone chain of a percarboxylic acid that is furthest from the percarboxyl group.

According to an embodiment of the invention, sulfoperoxycarboxylic acids have the following general formula:

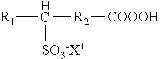

wherein R₁ is hydrogen, or a substituted or unsubstituted alkyl group; R₂ is a substituted or unsubstituted alkyl group; X is hydrogen, a cationic group, or an ester forming moiety; or salts or esters thereof.

In some embodiments, R₁ is a substituted or unsubstituted Cₘ alkyl group; X is hydrogen a cationic group, or an ester forming moiety; R₂ is a substituted or unsubstituted Cₙ alkyl group; m=1 to 10; n=1 to 10; and m+n is less than 18, or salts, esters or mixtures thereof. In some embodiments, R₁ is hydrogen. In other embodiments, R₁ is a substituted or unsubstituted alkyl group. In some embodiments, R₁ is a substituted or unsubstituted alkyl group that does not include a cyclic alkyl group. In some embodiments, R₁ is a substituted alkyl group. In some embodiments, R₁ is an unsubstituted C₁-C₉ alkyl group. In some embodiments, R₁ is an unsubstituted C₇ or C₈ alkyl. In other embodiments, R₁ is a substituted C₈-C₁₀ alkyl group. In some embodiments, R₁ is a substituted C₈-C₁₀ alkyl group is substituted with at least 1, or at least 2 hydroxyl groups. In still yet other embodiments, R₁ is a substituted C₁-C₉ alkyl group. In some embodiments, R₁ is a substituted C₁-C₉ substituted alkyl group is substituted with at least 1 SO₃H group. In other embodiments, R₁ is a C₉-C₁₀ substituted alkyl group. In some embodiments, R₁ is a substituted C₉-C₁₀ alkyl group wherein at least two of the carbons on the carbon backbone form a heterocyclic group. In some embodiments, the heterocyclic group is an epoxide group.

In further embodiments, R₂ is a substituted C₁-C₁₀ alkyl group. In some embodiments, R₂ is a substituted C₈-C₁₀ alkyl. In some embodiments, R₂ is an unsubstituted C₆-C₉ alkyl. In other embodiments, R₂ is a C₈-C₁₀ alkyl group substituted with at least one hydroxyl group. In some embodiments, R₂ is a C₁₀ alkyl group substituted with at least two hydroxyl groups. In other embodiments, R₂ is a C₉ alkyl group substituted with at least one SO₃H group. In some embodiments, R₂ is a substituted C₉ group, wherein at least two of the carbons on the carbon backbone form a heterocyclic group. In some embodiments, the heterocyclic group is an epoxide group. In some embodiments, R₁ is a C₈-C₉ substituted or unsubstituted alkyl, and R₂ is a C₇-C₈ substituted or unsubstituted alkyl.

Additional sulfoperoxycarboxylic acids suitable for use in the peracid compositions of the invention include, for example, the following and/or any salts, esters and mixtures thereof:

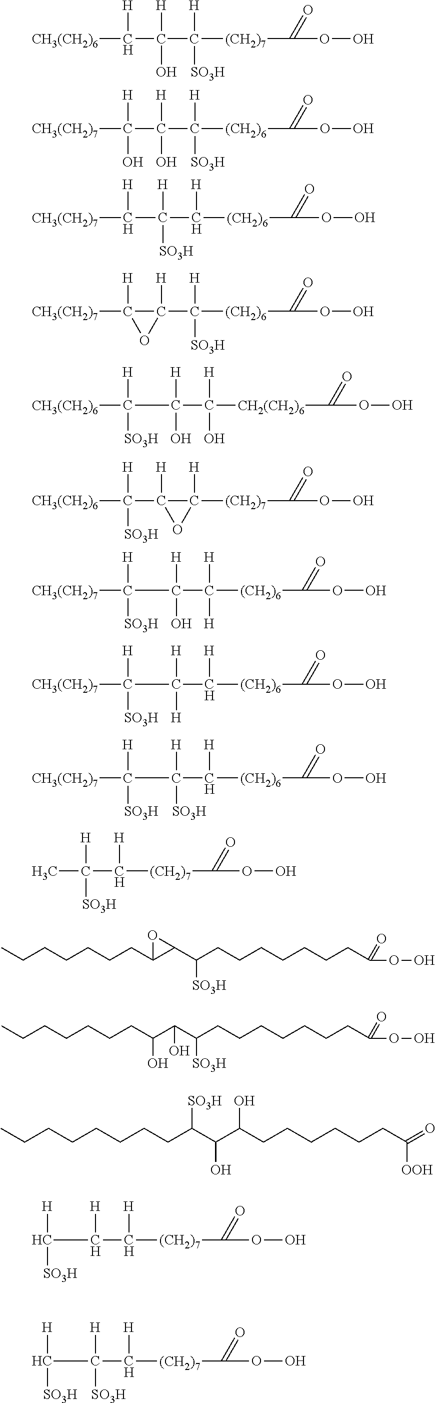

Further description of suitable sulfoperoxycarboxylic acids, and methods of making the same, according to the invention are included in U.S. patent application Ser. Nos. 13/290,355, 12/568,493 and 12/413,179, entitled “Sulfoperoxycarboxylic Acids, Their Preparation and Methods of Use as Bleaching and Antimicrobial Agents,” hereby expressly incorporated herein in its entirety by reference, including without limitation all drawings and chemical structures contained therein.

In some embodiments of the invention at least one carboxylic acid is employed in the peroxycarboxylic acid compositions due to the formulation of the dry powder compositions using an equilibrium peroxycarboxylic acid as the active oxygen oxidant. Generally, carboxylic acids have the formula R—COOH wherein the R can represent any number of different groups including aliphatic groups, alicyclic groups, aromatic groups, heterocyclic groups, and ester groups, such as alkyl ester groups, all of which can be saturated or unsaturated and/or substituted or unsubstituted. Carboxylic acids can have one, two, three, or more carboxyl groups. Preferred ester groups include aliphatic ester groups, such as R₁OC(O)R₂— where each of R₁ and R₂ can be aliphatic, preferably alkyl, groups described above for R. Preferably R₁ and R₂ are each independently small alkyl groups, such as alkyl groups with 1 to 4 carbon atoms.

The composition of the invention can employ carboxylic acids containing as many as 22 carbon atoms. Examples of suitable carboxylic acids include formic, acetic, propionic, butanoic, pentanoic, hexanoic, heptanoic, octanoic, nonanoic, decanoic, undecanoic, dodecanoic, lactic, maleic, ascorbic, citric, hydroxyacetic (glycolic), neopentanoic, neoheptanoic, neodecanoic, oxalic, malonic, succinic, glutaric, adipic, pimelic suberic, and sebacic acid. Examples of suitable alkyl ester carboxylic acids include monomethyl oxalic acid, monomethyl malonic acid, monomethyl succinic acid, monomethyl glutaric acid, monomethyl adipic acid, monomethyl pimelic acid, monomethyl suberic acid, and monomethyl sebacic acid; monoethyl oxalic acid, monoethyl malonic acid, monoethyl succinic acid, monoethyl glutaric acid, monoethyl adipic acid, monoethyl pimelic acid, monoethyl suberic acid, and monoethyl sebacic acid; monopropyl oxalic acid, monopropyl malonic acid, monopropyl succinic acid, monopropyl glutaric acid, monopropyl adipic acid, monopropyl pimelic acid, monopropyl suberic acid, and monopropyl sebacic acid, in which propyl can be n- or isopropyl; and monobutyl oxalic acid, monobutyl malonic acid, monobutyl succinic acid, monobutyl glutaric acid, monobutyl adipic acid, monobutyl pimelic acid, monobutyl suberic acid, and monobutyl sebacic acid, in which butyl can be n-, iso-, or t-butyl.

In some embodiments, the carboxylic acid for use with the compositions of the present invention is a C₂ to C₁₂ carboxylic acid. In some embodiments, the carboxylic acid for use with the compositions of the present invention is a C₅ to Cᵢᵢ carboxylic acid. In some embodiments, the carboxylic acid for use with the compositions of the present invention is a C₁ to C₄ carboxylic acid. Examples of suitable carboxylic acids include, but are not limited to, formic, acetic, propionic, butanoic, pentanoic, hexanoic, heptanoic, octanoic, nonanoic, decanoic, undecanoic, dodecanoic, as well as their branched isomers, lactic, maleic, ascorbic, citric, hydroxyacetic, neopentanoic, neoheptanoic, neodecanoic, oxalic, malonic, succinic, glutaric, adipic, pimelic subric acid, and mixtures thereof. Carboxylic acids that are generally useful include ester carboxylic acids, such as alkyl ester carboxylic acids.

The active oxygen oxidant can also include a mixture of compounds, such as more than one peroxycarboxylic acid. As used herein, the terms “mixed” or “mixture” when used relating to “peroxycarboxylic acid composition” or “peroxycarboxylic acids” refer to a composition or mixture including more than one peroxycarboxylic acid, such as a composition or mixture including peroxyacetic acid (POAA) and peroxyoctanoic acid (POAA). According to one embodiment, the composition includes more than one C₁-C₂₂ peroxycarboxylic acids. According to one embodiment, the composition includes one or more small C₂-C₄ peroxycarboxylic acids, one or more large C₈-C₁₂ peroxycarboxylic acids, one or more ester peroxycarboxylic acids, one or more alkyl ester peroxycarboxylic acids, and/or one or more mono- or di-peroxycarboxylic acid having up to 12 carbon atoms. According to a further embodiment, the peroxycarboxylic acid has from 2 to 12 carbon atoms. According to an embodiment, the peroxycarboxylic acids include peroxyacetic acid (POAA) (or peracetic acid having the formula CH₃COOOH) and/or peroxyoctanoic acid (POOA) (or peroctanoic acid having the formula, for example, of n-peroxyoctanoic acid (CH₃ (CH₂)₆COOOH).

In a preferred aspect, the active oxygen oxidant is a peroxycarboxylic acid and/or sulfonated peroxycarboxylic acid. The use of these active oxygen oxidants is distinct from various “non-dry water” applications using oxygen oxidants for the subsequent in situ generation of a peroxyacid. For example, U.S. Pat. No. 7,435,714, which is herein incorporated by reference in its entirety, discloses the use of sodium percarbonate as a bleaching agent for the subsequent in situ generation of a peroxyacid upon dissolution into a wash at a point of use. Beneficially, the dry active oxygen composition according to the present invention directly deliver peroxyacids or peroxycarboxylic acids in the dry-to-touch powder formulations without subsequent in situ generation required due to the formation of the stable composite powder compositions having an adsorbed outer layer of a porous hydrophobic particulate and an inner liquid layer of the active oxygen oxidant.

In a still further preferred aspect, the active oxygen oxidant is not sodium or other alkali metal percarbonate. Preferably, the active oxygen oxidant is an equilibrium composition of a hydrogen peroxide oxidant, a peroxycarboxylic acid and/or sulfonated peroxycarboxylic acid, and the corresponding carboxylic acids thereof. In still further preferred aspects, the active oxygen oxidant is an equilibrium peroxycarboxylic wherein the peracid exists in equilibrium with its corresponding carboxylic acid and the hydrogen peroxide oxidizing agent.

In some aspects, the aqueous solution of the active oxygen oxidant has a pH of about 8 or less. In further aspects, the aqueous solution of the active oxygen oxidant has a pH of about 7 or less, about 6 or less, about 5 or less or about 4 or less.

In an aspect, the compositions include from about 1 wt-%-99 wt-% active oxygen component, from about 50 wt-%-97 wt-% active oxygen component, from about 60 wt-%-95 wt-% active oxygen component, preferably from about 70 wt-%-95 wt-% active oxygen component. In addition, without being limited according to the invention, all ranges recited are inclusive of the numbers defining the range and include each integer within the defined range. As referred to herein, the weight percentage range of the active oxygen component includes the total amount of an equilibrium formulation in the event the active oxygen component is a peroxycarboxylic acid, having an equilibrium of the peroxycarboxylic acid, carboxylic acid and the hydrogen peroxide.

In an aspect, the ratio of the active oxygen component to the hydrophobic particulate component is from about 70:30 to about 98:2. In a further aspect, the ratio of the active oxygen component to the hydrophobic particulate component is from about 80:20 to about 97:3, preferably from about 90:10 to about 95:5. The weight ratios of the dry powder compositions according to the invention referring to the active oxygen component include the concentration by weight of the entire aqueous liquid component of the compositions. For example, in some aspects the inner liquid phase of the compositions may further include active oxygen stabilizing components, water and/or additional functional ingredients as disclosed herein according to embodiments of the invention. Without being limited according to the invention, all ranges recited are inclusive of the numbers defining the range and include each integer within the defined range and when referring to the active oxygen components may also include the additional optional liquid or aqueous components of the compositions.

Active Oxygen Stabilizers

The compositions according to the invention include an active oxygen stabilizer. The active oxygen stabilizer remains in solution or in a liquid suspension with the active oxygen component within the dry powder compositions. Exemplary active oxygen stabilizers include organic acids, chelants or sequestrants, free radical scavengers or mixtures thereof, which provide enhanced stability of the active oxygen component and may also provide beneficial effects on the cleaning action of the compositions.

Suitable active oxygen stabilizer include water-soluble organic chelating compounds that sequester metal ions in solution, particularly transition metal ions. Such sequestrants include organic amino- or hydroxy-polyphosphonic acid complexing agents (either in acid or soluble salt forms), carboxylic acids (e.g., polymeric polycarboxylate), hydroxycarboxylic acids, or aminocarboxylic acids. A particularly suitable organic acid for use as the active oxygen stabilizers is acetic acid.

Particularly suitable chelants for use as the active oxygen stabilizers include, for example, phosphates, phosphonates, diethylenetriaminepentaacetic acid (DTPA), dipicolinic acid, and the like. The sequestrant can be or include phosphonic acid or phosphonate salt. Suitable phosphonic acids and phosphonate salts include 1-hydroxy ethylidene-1,1-diphosphonic acid (CH₃C(PO₃H₂)₂OH) (HEDP); ethylenediamine tetrakis methylenephosphonic acid (EDTMP); diethylenetriamine pentakis methylenephosphonic acid (DTPMP); cyclohexane-1,2-tetramethylene phosphonic acid; amino[tri(methylene phosphonic acid)]; (ethylene diamine[tetra methylene-phosphonic acid)]; 2-phosphene butane-1,2,4-tricarboxylic acid; or salts thereof, such as the alkali metal salts, ammonium salts, or alkyloyl amine salts, such as mono, di, or tetra-ethanolamine salts; or mixtures thereof. Suitable organic phosphonates include HEDP.

The sequestrant can be or include aminocarboxylic acid type sequestrant. Suitable aminocarboxylic acid type sequestrants include the acids or alkali metal salts thereof, e.g., amino acetates and salts thereof. Suitable aminocarboxylates include N-hydroxyethylaminodiacetic acid; hydroxyethylenediaminetetraacetic acid, nitrilotriacetic acid (NTA); ethylenediaminetetraacetic acid (EDTA); N-hydroxyethylethylenediaminetriacetic acid (HEDTA); diethylenetriaminepentaacetic acid (DTPA); and alanine-N,N-diacetic acid; and the like; and mixtures thereof.

Particularly suitable free radical scavengers for use as the water-soluble active oxygen stabilizers include, for example, ascorbic acid or tocopherol acetate. Additional free radical scavengers may also include antioxidants.

In some aspects, the aqueous solution of the active oxygen oxidant and the stabilizer has a pH of about 8 or less. In further aspects, the aqueous solution of the active oxygen oxidant and the stabilizer has a pH of about 7 or less, about 6 or less, about 5 or less or about 4 or less.

In an aspect, the compositions include from about 0 wt-%-25 wt-% stabilizer, from about 0.01 wt-%-25 wt-% stabilizer, from about 0.1 wt-%-25 wt-% stabilizer, preferably from about 0.1 wt-%-10 wt-% active oxygen component. In addition, without being limited according to the invention, all ranges recited are inclusive of the numbers defining the range and include each integer within the defined range.

Additional Functional Ingredients

The components of the dry active oxygen compositions according to the invention can further be combined with various functional components suitable for use in a variety of applications employing active oxygen cleaning compositions. In some embodiments, the compositions including the active oxygen component (provided in an aqueous formulation), the hydrophobic silica component and optionally the active oxygen stabilizing component make up a large amount, or even substantially all of the total weight of the dry active oxygen compositions. For example, in some embodiments few or no additional functional ingredients are disposed therein.

In other embodiments, additional functional ingredients may be included in the compositions. The functional ingredients provide desired properties and functionalities to the active oxygen-containing compositions. For the purpose of this application, the term “functional ingredient” includes a material that when dispersed or dissolved in the dry-to-touch powder compositions used for providing an active oxygen composition to a point of use, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning applications, specifically biocide and/or bleaching applications. However, other embodiments may include functional ingredients for use in other applications.

In preferred embodiments, the compositions do not include surfactants. Without being limited to a particular theory of the invention, surfactants are not included with the active oxygen compounds as they are incompatible. In an aspect the surfactants cause wetting of the adsorbed particulate layer and the subsequent collapse of the composite powder into a liquid. In additional preferred embodiments, the compositions do not include materials insoluble in the liquid portion of the composite composition. In other embodiments, the compositions may include for example, catalyst, anti-redeposition agents, additional bleaching agents, bleach activators, solubility modifiers, dispersants, metal protecting agents, stabilizing agents, corrosion inhibitors, enzymes, antimicrobial agents, sequestrants and/or chelating agents, fragrances and/or dyes, rheology modifiers or thickeners, buffers and/or pH modifiers, solvents (e.g. hydrophilic substituents for maintaining the liquid phase within the dry powder compositions), preservatives, other polymers, water and the like.

Bleach Activators

In an aspect, the dry active oxygen compositions may be further formulated to include additional compositions of the hydrophobic particulate components surrounding a droplet of an aqueous solution of a bleach activator. In such an aspect, it may be desirable to have within a single composition the encapsulated bleach activators provided simultaneously with the encapsulated active oxygen components of the invention. In some aspects, by combining the dry active oxygen compositions with the encapsulated aqueous compositions of bleach activators, a self-activating composition of active oxygen compositions, namely peroxycarboxylic acid compositions, are provided in a shelf stable manner.

A bleach activator enhances the bleaching performance of a peracid composition. Notably, as referred to herein, the bleach activator is not a compound that reacts with a hydrogen peroxide (or other oxidizing agent) to form a peracid (or the activated peroxygen bleaching compound). Instead, the bleach activator according to the invention enhances bleaching performance of the peracid composition itself. In an aspect, a non-metal bleaching activator is employed. In an aspect, the bleach activator is a nitrogen-containing compound, preferably a polymeric amine. In a further aspect, the bleach activator is a polymeric amine or a polyamine. Preferred polymeric amines include, for example, polyethyleneimine compounds (PEI) and/or its derivatives. Polyethyleneimines may include primary, secondary or tertiary amine compounds. The polyethyleneimine compounds and/or its derivatives may include linear and/or branched polyethyleneimines. Still further, polyethyleneimines and/or its derivatives can vary significantly in molecular weight, topology and shape, including for example linear, branched or comb-like structures as a result of ring-opening polymerization of the ethylenimine. See Angelescu et al., Langmuir, 27, 9961-9971 (2011), which is incorporated herein by reference in its entirety. According to an aspect of the invention, the bleach activator may be a linear and/or branched polyethyleneimine, additional disclosure of which is set forth in U.S. patent application Ser. No. 13/661,352, titled “Amine Salt Activation of Peroxycarboxylic Acids,” which is herein incorporated by reference in its entirety.

Suitable polyethyleneimine compounds useful in the present invention may contain a mixture of primary, secondary, and tertiary amine substituents. The mixture of primary, secondary, and tertiary amine substituents may be in any ratio, including for example in the ratio of about 1:1:1 to about 1:2:1 with branching every 3 to 3.5 nitrogen atoms along a chain segment. Alternatively, suitable polyethyleneimine compounds may be primarily one of primary, secondary or tertiary amine substituents. Exemplary PEI products include multifunctional cationic polyethyleneimines with branched polymer structures according to the following formulas (—(CH₂—CH₂—NH)ₙ—), with a molecular mass of 43.07 (as repeating units). In certain aspects the formula (—(CH₂—CH₂—NH)ₙ—) has a value of n that is at least 10 to 10⁵, and wherein the nitrogen to carbon ratio is 1:2. PEI polymers have the general following polymer structure:

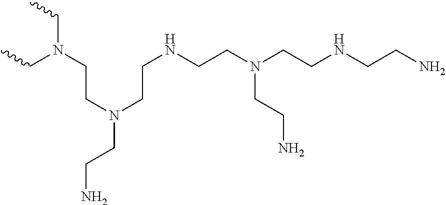

PEI products can also be represented by the following general formula, which may vary according to substitutions, size, molecular weight, branching, and the like:

(—NHCH₂CH₂—)ₓ[—N(CH₂CH₂NH₂)CH₂CH₂—]_{y}

wherein x is an integer that is 1 or greater and y is an integer that is 1 or greater than 1. Preferably, wherein x is an integer from about 1 to about 120,000, preferably from about 2 to about 60,000, more preferably from about 3 to about 24,000 and y is an integer from about 1 to about 60,000, preferably from about 2 to about 30,000, more preferably from about 3 to about 12,000.

Various commercial polyethyleneimines are available, including for example those sold under the tradename Lupasol® (BASF), including for example Lupasol® FG, Lupasol® G, Lupasol® PR 8515, Lupasol® WF, Lupasol® G 20/35/100, Lupasol® HF, Lupasol® P, Lupasol® PS, Lupasol® PO 100, Lupasol® PN 50/60, and Lupasol® SK. Such exemplary polyethyleneimines are available as anhydrous polyethyleneimines and/or modified polyethyleneimines provided in aqueous solutions or methoyxypropanol (Lupasol® PO 100). The molar mass of the polyethyleneimines, including modified polyethyleneimines can vary from about 800 g/mol to at least 2,000,000 g/mol.

In certain aspects the polymeric amine bleach activators, and preferably the PEI bleach activators, may be a branched, spherical polymeric amine. In further aspects, the molecular weight of the polymeric amine bleach activators or PEI bleach activators is from about 100 Daltons to about 2 million Daltons (PEI-2,000,000), more preferably from about 100 Daltons to about 1 million Daltons (PEI-1,000,000), more preferably from about 500 Daltons to about 500 kDa (PEI-500,000), more preferably from about 500 Daltons to about 50 kDa (PEI-50,000), more preferably from about 800 Daltons to about 50 kDa (PEI-50,000), more preferably from about 800 Daltons to about 10 kDa (PEI-10,000).

In further aspects, the charge density of the PEI or PEI salt is from about 15 mEq/g to about 25 mEq/g, more preferably from about 16 mEq/g to about 20 mEq/g. Commercially-available examples of such preferred PEIs include the BASF products LUPASOL® WF (25 kDa; 16-20 mEq/g) and Lupasol® FG (800 Daltons; 16-20 mEq/g), and the BASF products in the SOKALAN® family of polymers, e.g., SOKALAN® HP20, SOKALAN® HP22 G, and the like.

In an aspect, a polymeric amine may contain other substituents and/or and copolymers. For example, a polymeric amine may also include substituents, including for example ethoxylates and propoxylates. In an aspect of the invention, the polymeric amine, such as a polyethyleneimines, are derivatized with ethylene oxide (EO) and/or propylene oxide (PO) side chains. In an exemplary aspect of the invention ethoxylated PEIs may be heavily branched, wherein the substitutable hydrogens on the primary and secondary nitrogens are replaced with ethoxylated chains containing varying degrees of repeating units. In an aspect, the bleach activator is a polyethyleneimine polymer with ethyleneoxide chains. Ethoxylation of PEIs increases the solubility of the bleach activator according to the invention. A polymeric amine may also include endcap substituents, including for example ethylenediamine. A variety of substituents and/or copolymers may be included in order to modify the solubility or any other physical characteristics of a particular polymeric amine employed as a bleach activator according to the invention.

Because of the presence of amine groups, PEI can be protonated with acids to form a PEI salt from the surrounding medium resulting in a product that is partially or fully ionized depending on pH. For example, about 73% of PEI is protonated at pH 2, about 50% of PEI is protonated at pH 4, about 33% of PEI is protonated at pH 5, about 25% of PEI is protonated at pH 8 and about 4% of PEI is protonated at pH 10. In general, PEIs can be purchased as their protonated or unprotonated form with and without water. The counter ion of each protonated nitrogen center is balanced with an anion of an acid obtained during neutralization. Examples of protonated PEI salts include, but are not limited to, PEI-hydrochloride salt, PEI-sulfuric acid salt, PEI-nitric acid salt, PEI-acetic acid salt PEI fatty acid salt and the like. In fact, any acid can be used to protonate PEIs resulting in the formation of the corresponding PEI salt compound.

### Embodiments

Exemplary ranges of preferred components of the dry-to-touch active oxygen powder compositions according to the invention are shown in Table 2 in weight percentage of the powder compositions encapsulating the aqueous or liquid-containing active oxygen component.

TABLE 2

| | First | Second | Third | Fourth |
|---|---|---|---|---|
| | Exemplary | Exemplary | Exemplary | Exemplary |
| Material | Range wt-% | Range wt-% | Range wt-% | Range wt-% |
| Hydrophobic | 0.1-30 | 1-20 | 1-10 | 1-5 |
| Silica | | | | |
| Component | | | | |
| Active Oxygen | 50-99 | 60-97 | 70-95 | 80-95 |
| Component | | | | |
| Active Oxygen | 0-25 | 0.01-25 | 0.1-25 | 0.1-10 |
| Stabilizing | | | | |
| Component | | | | |
| Additional | 0-50 | 0-30 | 0.01-30 | 0.1-25 |
| Functional | | | | |
| Ingredients | | | | |

In an aspect the active oxygen component may include a varying amount of water and/or other solvents. In an aspect, the active oxygen component includes from about 0 wt-% to about 70 wt-% water, preferably from about 0.1 wt-% to about 40 wt-%, from about 1 wt-% to about 30 wt-%, or from about 2 wt-% to about 20 wt-% water.

According to an aspect of the invention, the dry active oxygen compositions may include a single active oxygen component surrounded by the dry powder composite compositions. In a further embodiment, the dry active oxygen compositions may include a plurality of active oxygen components surrounded by the dry powder composite compositions. In still further aspects, the dry-to-touch powder compositions may employ a single type of adsorbed particulate component (i.e. hydrophobic shell component) or a plurality of adsorbed particulates. Beneficially, the dry powders delivering active oxygen compounds are low or no odor compositions.

According to a further aspect, the dry active oxygen compositions provide a stable active oxygen oxidant. The term “stable” as applied herein to an active oxygen oxidant within the dry powder compositions according to the invention means a composition that retains at least about 90% of the active oxygen oxidant for at least about 6 months in a sealed container, or that retains at least about 90% of the active oxygen oxidant for at least about 3 months in a sealed container. In an aspect, composition may have improved stability within a sealed container having a venting device as a safety feature.

The compositions enable the formulation of concentrated active oxygen compounds. Beneficially, due to the adsorbed outer composite structure of the compositions the need for personal protective equipment for those handling the compositions is reduced. The compositions also provide the formulation of unit dose delivery, which may be applied to a surface or article in need of treatment and a remainder of the compositions may be stored in a sealed container for prolonged stability.

Kits

The dry active oxygen compositions may be provided in the form of a kit. In an aspect, a kit may comprise, consist of and/or consist essentially of a sealed container (with or without a venting feature for improved safety), the dry active oxygen compositions according to the invention, and instructions for application of use.

The kits can further include the components for treating the surfaces and/or articles disclosed in the methods of using the compositions. In an aspect, the instructions for how to use the compositions include instructions for treating the surfaces and/or articles. In some aspects, the kits are especially suited for consumer use.

Methods of Making

The dry active oxygen compositions according to the invention may be made by combining the liquid or aqueous active oxygen component composition with the hydrophobic particulate component under low, medium, or high shear mixing conditions. High shear mixing may further include vigorous agitation of the liquid or aqueous components with the hydrophobic shell component for a sufficient amount of time to form the dry-to-touch powder compositions. In some aspects, the shear mixing or agitation is required for a period of time from about a few minutes to at least an hour.

In an aspect, high shear mixing conditions are referred to herein to include, for example, the use of rotor or impellor, often with the use of a stationary component (e.g. stator or an array of rotors and stators) with are used within a tank or container with the liquid component to be mixed, or using other configurations as one skilled in the art is familiar with to create various emulsions, suspensions, lyosols and/or granular products.

Additional aspects of the methods of making the dry active oxygen compositions are disclosed for example in the treatment of hydrophobic particles for an adsorbed outer layer using vigorous agitation or aerosolization of a solution in the presence of the hydrophobic particles to form a solid powder, such as described in U.S. Pat. Nos. 7,030,071, 6,716,885, 5,342,597, 4,008,170 and 3,393,155, and by Formy et al., Powder Technology 171 (2007) 15-24, which are herein incorporated by reference in their entirety.

In an aspect, the use of high shear mixing (or other method) of a liquid active oxygen component (e.g. peroxyacid composition) in the presence of the hydrophobic adsorbed particulate component (e.g. fumed silica modified with hydrophobic components) in approximately a 98:2 weight ratio to about 80:20 weight ratio, a dry powder composition having a liquid active oxygen component disposed therein can is formed. In an aspect, the hydrophobic shell component (e.g. silica) forms a layer of adsorbed insoluble fine particles or nanoparticles floating on the surface of a the liquid portion (e.g. solution of an equilibrium peroxyacid composition). Alternatively, other hydrophobic particles or nanoparticles (e.g. alumina or clays, as disclosed according to the compositions) and/or other active oxygen components can be used according to the methods of the invention to form composite active oxygen compositions in the form of dry-to-touch, free flowing powders.

In an alternative aspect, the dry active oxygen compositions according to the invention may be made by aerosolization and/or fluidized bed spray for the outer adsorbed coating with the hydrophobic particulate component. As one skilled in the art will ascertain, methods of spraying or atomizing a liquid and a particulate stream together into air could be used to form the composite compositions.

In a further aspect of the invention, the methods of making the dry active oxygen compositions may further include the step of maintaining the encapsulated active oxygen components in a substantially non-reactive state. For example, according to the invention, the dry active oxygen compositions may be maintained at ambient temperatures, low humidity, etc. to prevent the dissolution of the hydrophobic adsorbed component into the aqueous or liquid phase of the composition. Further, according to the invention, the composite composition might be placed into contact with a glass surface to begin dispensing of the interior liquid by destabilizing the composite.

Beneficially, according to aspects of the invention, the dry active oxygen compositions according to the invention may be either stored in a sealed container or vented container or applied for a particular method of use according to the invention. In an aspect, the dry active oxygen compositions have a shelf-stability of at least about 2 to 6 months within a sealed container, preferably at least about 6 to 12 months within a sealed container. In another aspect, the dry active oxygen compositions applied to a surface in need of treatment have a stability of at least a few hours to at least a few days, preferably at least a few days to a few weeks, and more preferably at least a few months before the powder compositions break apart when rubbed or contacted against a surface to release the active oxygen component.

Methods of Use

The dry active oxygen compositions according to the invention may be employed to deliver active oxygen compounds for a variety of applications of use, including cleaning, disinfecting and/or sanitizing surfaces. Beneficially, the aqueous solution of an active oxygen component (e.g. bleach or an equilibrium peracid such as peracetic acid compositions) is surrounded by an undissolved particulate shell allowing for the aqueous solution to be delivered in a dry format, which may be referred to as a liquid powder. The particles do not release the active oxygen component until they are disrupted, allowing for the careful control of where the compositions are applied to prevent damage to sensitive areas and/or preclude the need for using personal protective equipment for persons handling concentrated compositions of the active oxygen component.

Delivery of the dry active oxygen compositions according to the invention may include a variety of low-pressure application techniques, using a variety of equipment known to those of skill in the art. In a further aspect of the invention, the delivery of the dry active oxygen compositions may include the spraying of the compositions onto a surface in need of treatment. In a further aspect of the invention, the delivery of the dry active oxygen compositions may include the spreading (without mechanical force, e.g. distributing or sprinkling the dry powder compositions over a surface). In a still further aspect, the delivery of the dry active oxygen compositions may include contact with a glass surface to begin dispensing of the interior liquid by destabilizing the composite.

Beneficially, according to aspects of the invention, the methods of using the dry active oxygen compositions minimize and/or do not require the use of personal protective equipment due to the encapsulation of the active oxygen component (e.g. bleach). As a further benefit, the methods of using the dry active oxygen compositions include the administration and use of a low or no odor compositions.

In some aspects, the dry active oxygen compositions are delivered to a point of use for example: concrete treatment, clothes dryer additive, pesticide delivery, point of use cleaning and/or disinfecting, delivery of composite with thickeners for various applications of use, lubricant for bottles/cans, hydrogen peroxide encapsulate for solids, desiccant for pest control, dry cleaning around electrical surfaces, eliminate spray boom in powder mixing in manufacturing setting, exterior building cleaning, fumigation alternative, bedbug treatment, fire retardant, composites of inorganic acids such as sulfuric acid for applications of use thereof, floor sweeping agent, carpet treatment, crop treatment, dry floor stripper, paper additive, ester-based solvents coating, ice melt, hide incompatible ingredients from each other, control coefficient of friction on floor, etc.

In an aspect, the dry active oxygen compositions are delivered to one or more of a variety of production facilities where an active oxygen oxidant, such as a peroxycarboxylic acid, might be used. Sites of use include, for example, a beverage plant, a food processing plant, a disassembly plant, a meat processing plant, wood pulp producing or paper plant, or the like. At the site of use, the dry active oxygen compositions can be applied to objects including equipment, containers, pulp, waste, and food products.

In an aspect, the dry active oxygen compositions may be dispersed or otherwise reacted with one or a plurality of reactants or other materials causing or promoting the disintegration of the of the adsorbed hydrophobic particulate component into the aqueous or liquid phase of the composition.

In another aspect, upon delivery of the dry active oxygen compositions to a treatment zone according to the invention, the compositions will either slowly break down due to the dispersion of the silica component into the aqueous liquid portion of the composition. In the alternative, mechanical or other force applied to the dry powder compositions can cause the silica component to disperse into the aqueous liquid portion of the composition or treatment zone, thereby making the active oxygen component available for the particular application of use. In some aspects, examples of force applied to the dry active oxygen compositions to liberate the liquid portion of the composition containing the active oxygen component for use, include for example, contact (e.g. person stepping on the compositions or otherwise touching the compositions), sharp force, pressure, rubbing and the like.

All publications and patent applications in this specification are indicative of the level of ordinary skill in the art to which this invention pertains. All publications and patent applications are herein incorporated by reference to the same extent as if each individual publication or patent application was specifically and individually indicated as incorporated by reference.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Example 1

A peracetic acid composition was evaluated under both low and high shear mixing conditions to evaluate the impact on mixing conditions employed for dry water technologies using active oxygen oxidants. The comparison of low and high shear mixing conditions were used to determine the compatibility of the active oxygen oxidants under various formation conditions. A Warring blender was charged with 50 grams deionized water, 50 grams Oxonia Active Concentrate, and 5 grams Aerosil R812S. The Oxonia Active Concentrate is a commercially available liquid mixture of peracetic acid, acetic acid, hydrogen peroxide, organophosphonate, and water (Ecolab Inc.). The Aerosil R812S is a commercially available hydrophobically modified silica (Evonik Industries).

The composition tested under high shear mixing conditions was blended for 1 minute using the high shear mixing (blender set on ‘high’ setting and ‘liquefy’). The mixture formed a dry-to-touch powder. The powder formed was a flowable powder composition. The compositions retained such flowable characteristic as a result of the liquid components of the composite remaining in aqueous solution and surrounded by an adsorbed outer layer of the hydrophobic silica.

The composition tested under low shear mixing conditions was mixed by hand for a few minutes to simulate low shear mixing. The active oxygen composition when mixed well by hand (e.g. low shear) did not form a dry powder. Instead, the composition remained a mixture of the starting materials in their original state.

### Example 2

A phosphonate-stabilized hydrogen peroxide composition was further evaluated for stability in formulating dry powder compositions according to the invention. A beaker was charged with 95 grams of hydrogen peroxide (35% dilution) stabilized with a phosphonate, and 5 grams Aerosil R812S. The hydrogen peroxide was employed as the active oxygen oxidant in place of the Oxonia Active Concentrate employed in Example 1. The Aerosil R812S is a commercially available hydrophobically modified silica (Evonik Industries).

The composition tested under high shear mixing conditions was blended for 1 minute and again formed a dry-to-touch powder that was a flowable powder composition. The substitution of the stabilized hydrogen peroxide provides a further example of an active oxygen oxidant that is capable of remaining as a liquid component surrounded by an adsorbed outer layer of the modified, hydrophobic silica.

The compositions were then held on a hand to determine the amount of contact time required before a change in composition (e.g. dry-to-touch powder back to liquid) was observed. The resulting dry powder containing the stabilized hydrogen peroxide did not bleach the skin for up to 30 minutes (demonstrating the stability of the composition and the very slow evaporation of the encapsulating hydrophobic silica surrounding the hydrogen peroxide over time). However, rubbing the dry-to-touch powder composition on the skin “activated” it, resulting in a bleaching time similar to that of liquid hydrogen peroxide (35%) alone, from between about 1-2 minutes. Beneficially, the formation of the dry-to-touch powder prevents the active oxygen oxidant from being activated for a period of time, enabling the storage of the compositions in sealed containers for extended periods of time to prevent the evaporation of the encapsulating silica or other agent. Thereafter an extended period of storage in a sealed container, the active oxygen containing compositions can be applied for a particular use to deliver the oxidant to a particular application of use and/or time for application.

### Example 3

The dry-to-touch powder compositions generated in Example 2 were further analyzed for stability of the active oxidant. The compositions were titrated initially and 24 hours later, giving nearly the same resulting amount of hydrogen peroxide concentration in the untreated liquid composition (35%) and the dry-to-touch powder composition (31%).

Notably, these results demonstrate a significant improvement in the retained oxidant concentration in the compositions formulated according to the invention, in comparison to the prior art, such as that reported in U.S. Patent Publication No. 2003/0160209, which is herein incorporated by reference in its entirety. The work of Hoffman et al. indicate that high concentrations of hydrogen peroxide require preparation immediately before use due to their instability; prior art compositions formulated using high concentrations of hydrogen peroxide demonstrated decomposition generating oxygen, requiring the formulation immediately prior to use. Such limitations were not required using the formulations according to the present invention.

### Example 4

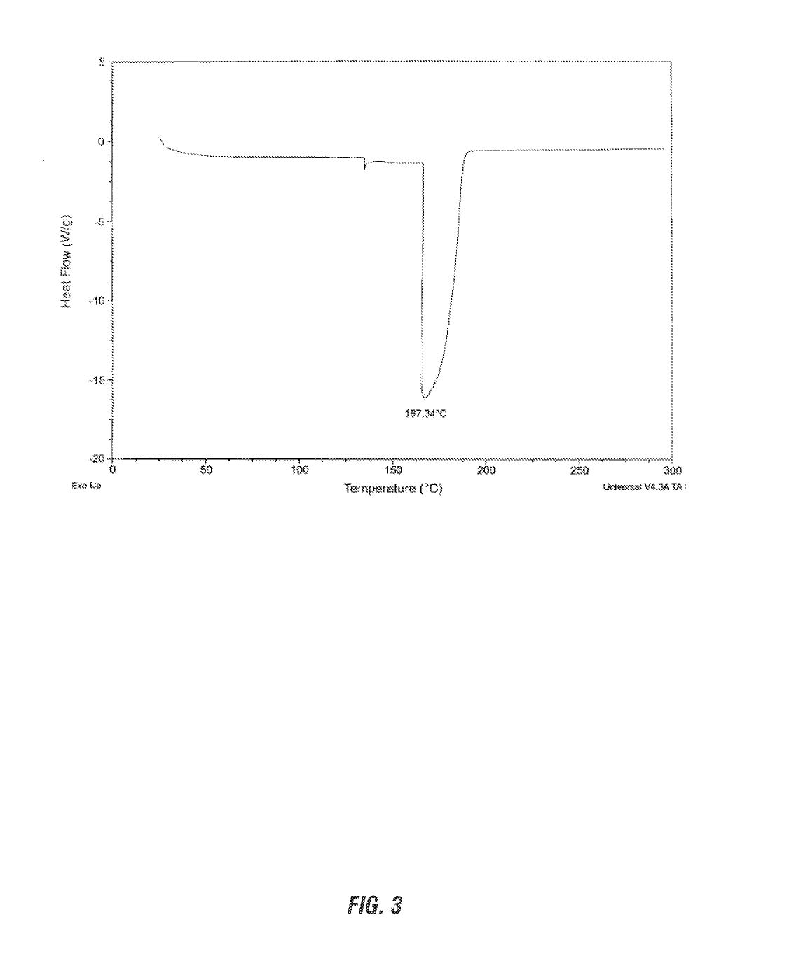

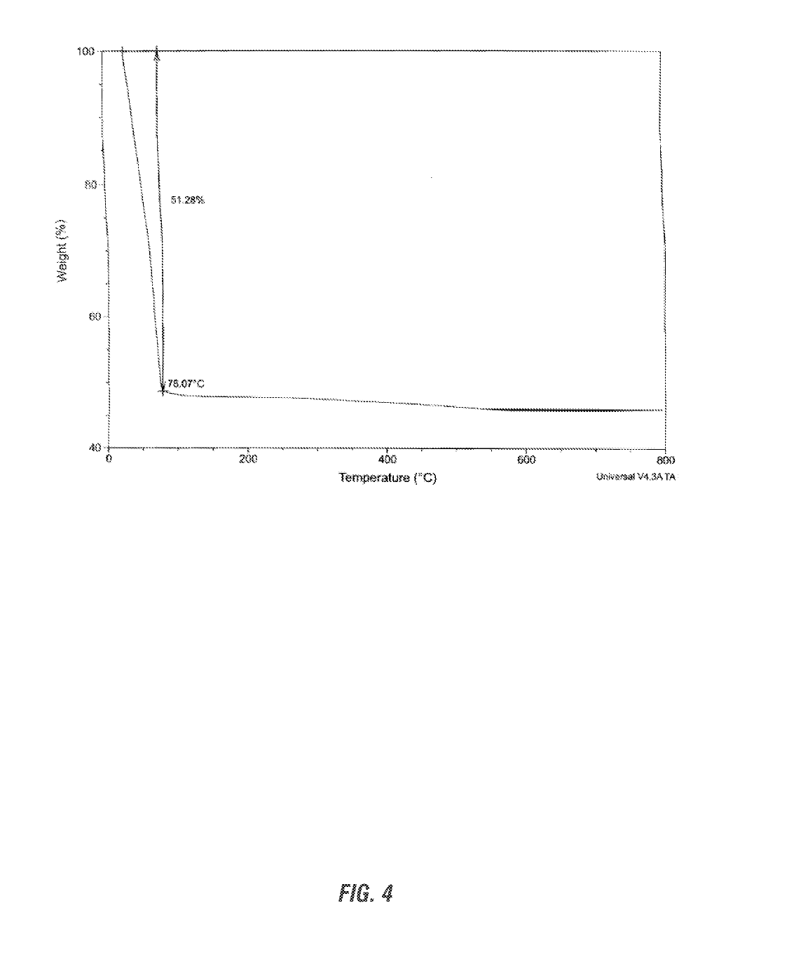

The thermostability of the dry-to-touch powder compositions according to exemplary embodiments of the invention were analyzed. A TGA Q500 was used to measure % weight lost from a sample over increasing temperatures, as shown in FIGS. 2 and 4, according to methods known in the art. A DSC Q200 was used to measure enthalpy changes as changes in heat flow (W/g) over increasing temperatures, as shown in FIG. 3.

FIG. 2 is a TGA for a dry powder formulation wherein the hydrophobic silica particulate component adsorbs to an outer layer of the liquid water phase (95 grams water and 5 grams fumed hydrophobic silica). FIG. 2 shows that when the powder composition was heated to about 96° C. approximately 95% of the sample weight was lost from the composition, corresponding closely with the theoretical level of 95% water present. This shows that the water component of the dry powder system is almost completely evaporated near the expected boiling point for water.

FIG. 4 is also a TGA for a dry powder formulation wherein the hydrophobic silica particulate component adsorbs to an outer layer of a liquid 50% active hydrogen peroxide aqueous phase (95 grams 50% hydrogen peroxide and 5 grams fumed hydrophobic silica). FIG. 4 shows about the theoretical level of weight loss corresponding to water loss as in FIG. 2 but surprisingly does not show a corresponding loss of the higher boiling hydrogen peroxide component.

FIG. 3 is a DSC of the same material as in FIG. 4. FIG. 3 shows an endothermic event occurring near 167° C. of unknown cause but unexpectedly did not show the expected exothermic decomposition of hydrogen peroxide over the range of test conditions, showing the hydrogen peroxide to be in a stabilized form.

The inventions being thus described, it will be obvious that the same may be varied in many ways. Such variations are not to be regarded as a departure from the spirit and scope of the inventions and all such modifications are intended to be included within the scope of the following claims.

1. A dry active oxygen composition comprising:
from about 50 wt.-% to about 99 wt.-% of a liquid aqueous active oxygen component having a pH of less than 8, wherein said active oxygen component is an aqueous solution of peroxycarboxylic acid, sulfonated peroxycarboxylic acid, hydrogen peroxide, persulfates, perborates, percarbonates, urea, or combinations thereof; and
from about 0.1 wt.-% to about 30 wt-% of a hydrophobic particulate component adsorbed as an outer layer surrounding said liquid active oxygen component,
wherein said composition is a flowable, dry-to-touch powder composition by formation of a composite of the liquid aqueous active oxygen component and the hydrophobic particulate component, wherein said hydrophobic particulate is adsorbed and not encapsulating onto the liquid aqueous active oxygen component, and wherein said hydrophobic particulate component does not dissolve within the liquid component for a period of time greater than at least 24 hours.

2. The composition of claim 1, wherein said active oxygen component is an aqueous solution of peroxycarboxylic acid, a sulfonated peroxycarhoxylic acid, and/or hydrogen peroxide.

3. The composition of claim 1, wherein said active oxygen component is an aqueous solution of an equilibrium peroxycarboxylic acid and/or sulfonated peroxycarhoxylic acid.

4. The composition of claim 1, wherein said active oxygen component has a pH of less than 7.

5. The composition of claim 1, wherein said hydrophobic component is a silica.

6. The composition of claim 5, wherein said silica component is not an alkali metal silicate, and wherein said silica component is a hydrophobically modified silica having at least about 30% of the hydroxyl groups of said silica modified with a silane to increase hydrophobicity.

7. The composition of claim 1, wherein the weight ratio of the liquid active oxygen component to the hydrophobic particulate component is about the radius of a droplet of the liquid component measured in μm divided by 3.

8. The composition of claim 1, wherein the ratio of said active oxygen component to said hydrophobic component is from about 80:20 to about 97:3.

9. The composition of claim 1, wherein the ratio of said active oxygen component to said hydrophobic component is from about 90:10 to about 95:5.

10. The composition of claim 8, wherein said composition further comprises an active oxygen stabilizing component selected from the group consisting of an organic acid, chelant, sequestrant and free radical scavenger, and/or further comprises an additional functional ingredient in the liquid component of the composition.

11. The composition of claim 1, wherein said composition remains stable in a sealed container for at least 6 months.

12. The composition of claim 1, wherein said composition further comprises a dry bleach activator composition comprising a hydrophobic component adsorbed as an outer layer surrounding an aqueous, non-metal bleach activator.

13. A kit comprising:
a sealed container;
a composite dry active oxygen composition comprising a liquid aqueous composition containing from about 50 wt-% to about 99 wt-% of an active oxygen component having a of less than 8, wherein said active oxygen component is an aqueous solution of peroxycarboxylic acid, sulfonated peroxycarboxylic acid, hydrogen peroxide, persulfates, perborates, percarbonates, urea, or combinations thereof, and from about 0.1 wt-% to about 30 wt-% of a hydrophobic particulate component adsorbed as an outer layer surrounding said active oxygen component, wherein said composition is a flowable, dry-to-touch powder composition by formation of a composite of the liquid aqueous active oxygen component and the hydrophobic particulate component, wherein said hydrophobic particulate is adsorbed and not encapsulating onto the liquid aqueous active oxygen component, and wherein said hydrophobic particulate component does not dissolve within the liquid component for a period of time greater than at least 24 hours; and
instructions for application of use.

14. The kit of claim 13, wherein the dry active oxygen composition further comprises a dry bleach activator composition comprising a hydrophobic particulate component adsorbed as an outer layer surrounding liquid aqueous bleach activator, wherein said bleach activator is a polymeric amine or a polyamine.

15. The kit of claim 13, wherein said dry active oxygen composition remains stable in said sealed container for at least 6 months.

16. A method of using a dry active oxygen composition comprising:
combining a liquid aqueous active oxygen component and an adsorbed hydrophobic particulate component to form a composite dry active oxygen composition, wherein said active oxygen component is an aqueous solution of peroxycarboxylic acid, sulfonated peroxycarboxylic acid, hydrogen peroxide, persulfates, perborates, percarbonates, urea, or combinations thereof, constitutes from about 50 wt-% to about 99 wt-% of the composition, and has a pH of less than 8, wherein said hydrophobic particulate component constitutes from about 0.1 wt-% to about 30 wt-% of the composition, wherein said active oxygen component is contained within said adsorbed layer of hydrophobic particulate component, wherein said composition is a flowable, dry-to-touch powder, wherein said hydrophobic particulate component does not dissolve within the liquid component for a period of time greater than at least 24 hours; and
applying said composite thy active oxygen composition to a surface in need of treatment thereof; and/or
storing said composite dry active oxygen composition within a sealed container for subsequent application to a surface in need of treatment.

17. The method of claim 16, wherein said composition does not dissolve into a liquid composition upon applying to said surface for at least 24 hours.

18. The method of claim 16, wherein said composition remains stable within said sealed container for at least about 6 months.

19. The method of claim 16, wherein said hydrophobic particulate component is dispersed into said active oxygen component upon a shear force contacting said composition.

20. The method of claim 16, wherein said hydrophobic particulate component is a hydrophobically modified silica having at least about 30% of the hydroxyl groups of said silica modified with a silane to increase hydrophobicity, and wherein the ratio of said active oxygen component to said hydrophobic component is from about 80:20 to about 97:3.
